(19) United States
(12) Patent Application Publication
(10) Pub. No.: US 2023/0172797 A1
(43) Pub. Date: Jun. 8, 2023

(54) FLEXIBLE VIBRATION CUSHION AND CONTROL METHOD FOR DRIVING THE SAME

(71) Applicants: Hyundai Motor Company, Seoul (KR); Kia Corporation, Seoul (KR); Korea Advanced Institute of Science and Technology, Daejeon (KR)

(72) Inventors: Kyoung Jin Chang, Suwon (KR); Dong Chul Park, Anyang (KR); Ki Uk Kyung, Daejeon (KR); Hyun Woo Kim, Daejeon (KR); Ji Hyeong Ma, Daejeon (KR); Jong Seok Nam, Daejeon (KR); Min Ki Kim, Daejeon (KR)

(21) Appl. No.: 17/963,663

(22) Filed: Oct. 11, 2022

(30) Foreign Application Priority Data
Dec. 7, 2021 (KR) 10-2021-0173333

(51) Int. Cl. A61H 23/02; B60N 2/879; A61H 23/04; B06B 1/02

(52) U.S. Cl. CPC A61H 23/02; A61H 23/04; B06B 1/0215; B06B 1/0292; B60N 2/879; A61H 2201/0134; A61H 2201/1654; A61H 2201/5005; A61H 2201/5048

(57) ABSTRACT

Disclosed are a flexible vibration cushion and a method of controlling the same. The flexible vibration cushion may include a cover member, a first soft filler material filled in the cover member; and a vibration generation device including components made of a soft material and disposed in the soft filler. The vibration generation device is configured to generate vibration as an electrostatic force is repeatedly generated and released. The vibration generation device may be applied in a vehicle part, e.g., headrest, thereby minimizing the foreign body sensation acting on the user’s skin while delivering soft and various senses of vibrations to the user.

### CROSS-REFERENCE TO RELATED APPLICATION

This application claims under 35 U.S.C. §119(a) the benefit of priority to Korean Patent Application No. 10-2021-0173333 filed on Dec. 7, 2021, the entire contents of which are incorporated herein by reference.

### TECHNICAL FIELD

The present invention relates to a flexible vibration cushion and a control method for driving the same. The flexible vibration cushion can deliver various senses of vibrations for massage to a user while minimizing foreign body sensation due to the contact of the user’s skin.

### BACKGROUND

If a passenger sits on a vehicle seat for a long time, pressure on the passenger’s body part in close contact with the seat can continue, thereby causing stiffness, muscle pain, etc. and to solve such a problem, a seat massage device capable of massaging the passenger’s body is installed on the vehicle seat.

In the related art, a massage device is known in which a cushion member with an acupressure projection and a vibration motor are embedded in a headrest so that the cushion member vibrates by driving the vibration motor and at the same time, the acupressure projection of the cushion member massages a user’s neck part.

However, the acupressure projection of the cushion member can vibrate in direct contact with the user’s skin, thereby causing the user’s inconvenience such as rather feeling the foreign body sensation.

Moreover, since the vibration motor and the acupressure projection of the cushion member embedded in the headrest are all composed of components made of hard materials, the foreign body sensation acting on the skin increases according to the degree of the user in close contact therewith, thereby increasing the user’s inconvenience.

In addition, in the related art, a massage mechanism may include a vibration motor and a rotary massager that are embedded in a jacket wearable by the user so that the message for the user’s body is carried out by the driving of the vibration motor or the rotation motion of the rotary massager.

However, since the vibration motor and the rotary massager are also all composed of components made of hard materials, the foreign body sensation acting on the skin increases according to the degree of the user in close contact therewith, thereby increasing the user’s inconvenience.

As described above, the components embedded in the conventional massage devices and massage mechanism are all made of hard materials, thereby increasing the foreign body sensation acting on the skin according to the degree of the user in close contact therewith to increase the user’s inconvenience. Therefore, there is a need for a vibration provision device to solve such a problem.

The above information disclosed in this Background section is only for enhancement of understanding of the background of the invention and accordingly it may include information that does not form the prior art that is already known in this country to a person of ordinary skill in the art.

### SUMMARY OF THE INVENTION

In preferred aspects, provided are a flexible vibration cushion and a method of controlling the same. The flexible vibration cushion may include a first soft filler material as a filler material to be filled to provide a cushion force into a cover member, and a flexible soft material to the respective components of a vibration generation device embedded in the cover member to provide a massage vibration, thereby minimizing the foreign body sensation acting on the user’s skin while delivering soft and various senses of vibrations to the user.

In an aspect, provided is a flexible vibration cushion that may include (i) a cover member; (ii) a first soft filler material filled in the cover member; and (iii) a vibration generation device including components made of a soft material and disposed in the first soft filler material and configured to generate vibration as an electrostatic force is repeatedly generated and released.

The vibration generation device may include a substrate coated with an electrode; an electroactive polymeric membrane bonded to a first surface portion of the substrate; a dielectric fluid injected into a space between the substrate and the electroactive polymeric membrane; and a flexible electrode coated on the dielectric fluid to face and contact the electrode of the substrate.

In addition, a second surface portion of the substrate may be further connected with a support structure configured to limit that the vibration generated by the vibration generation device may be absorbed into or reflected from the first soft filler material on a second side of the substrate. The “first surface portion” and “second surface portion” as used herein refer to surfaces facing to opposite directions, e.g., front surface of a substrate and a rear surface of the substrate.

The electroactive polymeric membrane may be formed of a convex membrane structure using a polymer material with an elastic force.

Preferably, the flexible electrode may be comprise one or more selected from a carbon nanotube, a metal nanoparticle, a graphene, a conductive polymer, and a hydrogel.

Preferably, the support structure comprises a material with different sizes and hardnesses according to the user purpose and the application of the vibration cushion.

Optionally, the electroactive polymeric membrane may include a PVC-gel material, a charge transfer terminal stacked between the electrode coated on the substrate and the flexible electrode coated on the electroactive polymeric membrane may be formed to extend from an outer end of the electroactive polymeric membrane.

Further, when a power source is supplied to the substrate, an electrostatic force may be generated between the electrode coated on the substrate and the flexible electrode coated on the electroactive polymeric membrane, and an outer end of the electroactive polymeric membrane is in close contact with an outer portion of the substrate. Preferably, the dielectric fluid may be pushed from the outside to the inside to pressurize a central portion of the electroactive polymeric membrane, and therefore, the central portion of the electroactive polymeric membrane can protrude forward for generating the vibration.

On the other hand, when the power source to the substrate is cut off, the electrostatic force generated between the electrode coated on the substrate and the flexible electrode coated on the electroactive polymeric membrane is released, and the outer end of the electroactive polymeric membrane is returned to an original position. Preferably, the pressure of the dielectric fluid pushing the central portion of the electroactive polymeric membrane may be released, and the central portion of the electroactive polymeric membrane can be contracted and retreated to the original position for generating the vibration.

Also provided is a vehicle part, particularly, a headrest of a vehicle that may include the vibration cushion as described herein and a second soft filler material with the hardness greater than that of the first soft filler material is further attached to a second side of the support structure of the vibration generation device.

The “first soft filler material” and “second soft filler material” as used herein may be the same or different. In certain aspect, the first soft filler material and the second filler material are different in physical properties or in chemical compositions. In particular, as used herein, the first soft filler material and the second filler material are different in hardness, for example, the second soft filler material may have hardness greater than that of hardness of the first soft filler material, e.g., by about 10%, by about 20%, by about 30%, by about 40%, by about 50%, by about 60%, by about 70%, by about 80% or by about 90%, or preferably by about 20 to 80% or by about 30 to 70%. In one aspect, hardness may assessed by Durometer hardness (e.g. ASTM D 2240), suitably Type A durometer assessment.

Also provided is a vehicle including the headrest as described herein.

In another aspect, provided is a method for controlling a flexible vibration cushion including applying, by a control unit, a target current in the form of a square wave pulse in which an ON section where a current is applied and an OFF section where the current is cut off are repeated to a substrate; expanding and protruding forward a central portion of an electroactive polymeric membrane by generating an electrostatic force between an electrode coated on the substrate and a flexible electrode coated on the electroactive polymeric membrane in the ON section; and contracting and retreating the central portion of the electroactive polymeric membrane to an original position by releasing the electrostatic force between the electrode coated on the substrate and the flexible electrode coated on the electroactive polymeric membrane in the OFF section. In particular, the central portion of the electroactive polymeric membrane protrudes forward and retreats to the original position repeatedly so that the vibration is generated.

The expanding and protruding forward of the central portion of the electroactive polymeric membrane may include closely contacting and contracting an outer end of the electroactive polymeric membrane with an outer portion of the substrate by generating the electrostatic force, pressurizing and pushing the dielectric fluid filled in the space between the electroactive polymeric membrane and the substrate from the outside to the inside, and serving the dielectric fluid as a pressure pushing the central portion of the electroactive polymeric membrane forward as it is pushed from the outside to the inside.

The contracting and retreating the central portion of the electroactive polymeric membrane to the original position may include separating the electroactive polymeric membrane and the substrate from each other by an original distance by returning the outer end of the electroactive polymeric membrane to the original position by releasing the electrostatic force, and releasing the pressure of the dielectric fluid pushing the central portion of the electroactive polymeric membrane forward.

The method for controlling the vibration cushion may further include providing any one vehicle information including a safety warning, a vehicle destination guidance, a stopover sign, and a proceeding direction of a vehicle to the control unit from a vehicle control unit; applying, by the control unit, a current application pattern suitable for the vehicle information to the substrate of a vibration generation device; and generating, by the vibration generation device, a vibration suitable for the vehicle information according to the current application pattern suitable for the vehicle information.

The method for controlling the vibration cushion may further include providing sound source information to the control unit from a vehicle control unit; selecting, by the control unit, a current application pattern suitable for sound source information to apply it to the substrate of a vibration generation device; and generating, by the vibration generation device, a vibration with a sense of rhythm according to the current application pattern suitable for the sound source information.

According to various exemplary embodiments of the present invention, not only the cover member that is the outer skin and the first soft filler material filled in the cover member but also the vibration generation device disposed in the first soft filler material to generate the vibration can include the soft material, thereby minimizing foreign body sensation, pain, etc. when the user’s skin contacts, and minimizing or preventing the phenomenon in which the local pressure concentration acts on the user’s body contacting the vibration cushion when the situation such as the collision of the vehicle occurs, thereby inflicting the injury.

Further, since there is no foreign body sensation even if the vibration generation device is driven when the user’s skin contacts the vibration cushion, the user can feel the soft and comfortable massage effect.

In addition, by allowing the user to freely modify the change in the vibration pattern including the vibration amplitude and frequency of the vibration generation device, various sense of the vibration may be delivered to the user, thereby allowing the user to select the desired sense of massage.

The vibration cushion according to various exemplary embodiments of the present invention can be used according to the user’s various taste and use, such as being used by being mounted in the headrest constituting the vehicle seat, formed in a standalone type to be mounted on the desired part of the seat, or used by being mounted on a bedding, a chair, etc.

The above and other features of the invention are discussed infra.

### BRIEF DESCRIPTION OF THE DRAWINGS

The above and other features of the present invention will now be described in detail with reference to certain exemplary examples thereof illustrated in the accompanying drawings which are given herein below by way of illustration only, and thus are not limitative of the present invention, and wherein:

FIG. 1 is a cross-sectional diagram showing an exemplary flexible vibration cushion according to an exemplary embodiment of the present invention.

FIG. 2 is a front diagram showing an exemplary vibration generation device of the flexible vibration cushion according to an exemplary embodiment of the present invention.

FIG. 3 is a cross-sectional diagram showing an exemplary vibration operation principle of the flexible vibration cushion according to an exemplary embodiment of the present invention.

FIG. 4 is a cross-sectional diagram showing an exemplary flexible vibration cushion according to an exemplary embodiment of the present invention.

FIG. 5 is a flowchart showing an exemplary control method for driving the flexible vibration cushion according to an exemplary embodiment the present invention.

FIG. 6 is a side cross-sectional diagram showing an example in which the flexible vibration cushion according to an exemplary embodiment of the present invention is mounted outside a headrest of a vehicle.

FIG. 7 is a side cross-sectional diagram showing an example in which the flexible vibration cushion according to an exemplary embodiment of the present invention is embedded in the headrest of the vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in section by the particular intended application and use environment.

In the figures, reference numbers refer to the same or equivalent sections of the present invention throughout the several figures of the drawing.

### DETAILED DESCRIPTION

Hereinafter, preferred exemplary embodiments of the present invention will be described in detail with reference to the accompanying drawings.

In the present specification, it should be understood that terms such as “include” and “have” are intended to denote the existence of mentioned characteristics, numbers, steps, operations, components, parts, or combinations thereof, but do not exclude the probability of existence or addition of one or more other characteristics, numbers, steps, operations, components, parts, or combinations thereof.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

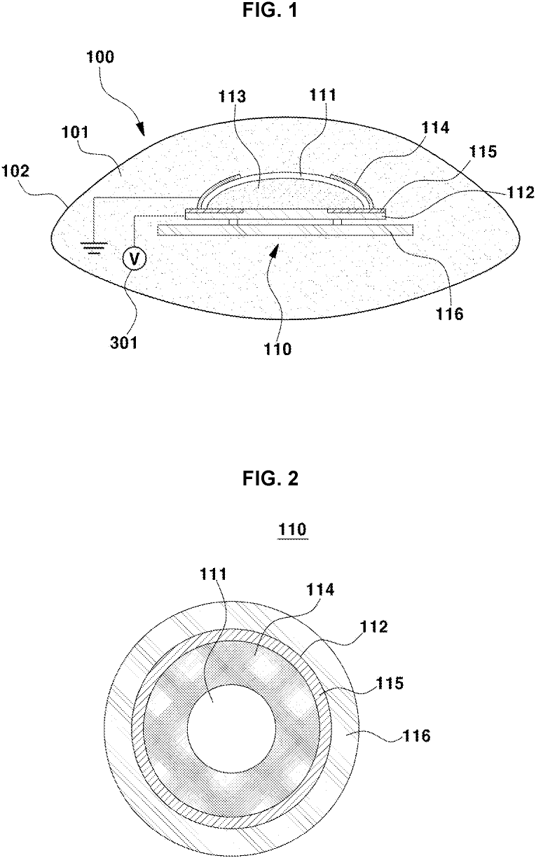

FIG. 1 is a cross-sectional diagram showing an exemplary flexible vibration cushion according to an exemplary embodiment of the present invention, and FIG. 2 is a front diagram showing an exemplary vibration generation device of the flexible vibration cushion according to an exemplary embodiment of the present invention.

As shown in FIG. 1, a vibration cushion 100 may include a cover member 102 that is an outer skin, a first soft filler material 101 made of a soft material and filled in the cover member 102, and a vibration generation device 110 disposed in the first soft filler material 101 to generate a substantial massage vibration.

The cover member 102 may be a part substantially contacting a user’s skin, and leather, fabric, etc. may be used to seal the first soft filler material 101, and in addition, various outer skin materials, etc. well known can be used.

The first soft filler material 101 as used herein refers to a material having buffer effects, e.g., absorbing impact, vibration, or external force, such as sponge, foam pad, with a sufficient softness at a level that can be naturally modified by the pressure when contacting the user’s body while maintaining a shape of the vibration cushion is preferably used. Polymer materials (e.g. polyethylene, polyester, polyurethane, and/or vegetal cellulose) suitably may be used as a first soft filler materials. Sponge materials including synthetic sponge materials also are suitable and may include various polymer materials.

In particular, the vibration generation device 110 of the vibration cushion 100 may also be provided in a structure in which components made of the soft material are assembled to each other to minimize foreign body sensation when contacting the user’s body.

To this end, as shown in FIGS. 1 and 2, the vibration generation device 110 may include a substrate 112 coated with an electrode 115, an electroactive polymeric membrane 111 attached to a first surface portion of the substrate 112, dielectric fluid 113 injected into a space between the substrate 112 and the electroactive polymeric membrane 111, and a flexible electrode 114 coated on the dielectric fluid 113 to face and contact the electrode 115 of the substrate 112.

In addition, a second surface portion of the substrate 112 may be further connected with a support structure 116 configured to limit that the vibrations generated in the electroactive polymeric membrane 111, the substrate 112, and the dielectric fluid 113 in a configuration of the vibration generation device 110 may be absorbed into or reflected from the first soft filler material 101 on a second side of the substrate 112.

The electroactive polymeric membrane 111 may be formed using a polymer material having an elastic fore so that expansion or contraction is possible, and bonded to the first surface portion of the substrate 112 so that a change in the physical shape is possible.

For example, the electroactive polymeric membrane 111 may be formed of a convex membrane structure using a polymer material with an elastic force and bonded to the first surface portion of the substrate 112, and may generate the vibration through repeated expansion and contraction motions as a change in the physical shape.

In addition, on the outer end of the electroactive polymeric membrane 111, the flexible electrode 114 capable of maintaining conductivity even in the change in the physical shape such as the vibration of the electroactive polymeric membrane 111 may be coated on or attached to the first surface portion of the electroactive polymeric membrane 111, and as a material of the flexible electrode 114, various conductive materials such as a carbon nanotube, a metal nanoparticle, a graphene, a conductive polymer, and a hydrogel can be used.

At this time, as the electroactive polymeric membrane 111 is formed in the shape of the convex membrane structure, a space for filling the dielectric fluid 113 is formed between the first surface portion of the substrate 112 and the second surface portion of the electroactive polymeric membrane 111.

Therefore, the dielectric fluid 113 may be easily injected into the space between the first surface portion of the substrate 112 and the second surface portion of the electroactive polymeric membrane 111.

Preferably, when the electroactive polymeric membrane 111 is bonded to the first surface portion of the substrate 112, the sealing may be made so that the dielectric fluid 113 injected into the space between the first surface portion of the substrate 112 and the second surface portion of the electroactive polymeric membrane 111 may not be leaked by leaving some local portions as a portion not bonded, injecting the dielectric fluid 113 through this portion not bonded, and then sealing the portion not bonded.

Since a first outer portion of the substrate 112 is coated with the electrode 115 in pair facing and conductively contacting the flexible electrode 114 coated on the electroactive polymeric membrane 111, the electrode 115 may be adopted as the flexible electrode depending upon the degree of flexibility of the substrate 112.

Meanwhile, the support structure 116 is a component located on the rearmost in the configuration of the vibration generation device 110 and surrounded by the first soft filler material 101, and may be formed in the size and material capable of changing the degree at which the vibrations generated in the electroactive polymeric membrane 111, the substrate 112, and the dielectric fluid 113 in the configuration of the vibration generation device 110 may be absorbed into or reflected from the first soft filler material 101 on the second side of the substrate 112.

Particularly, since the support structure 116 is advantageous for delivering more senses of vibrations when a contact surface with the first soft filler material 101 is made of a broad and hard material but can lower the soft contact satisfaction of the vibration cushion 100, the support structure 116 may be formed by selecting a material with an appropriate size and hardness according to the use purpose and application of the vibration cushion, thereby adjusting the degree at which the vibration delivered from the support structure is absorbed into or reflected from the first soft filler material 101.

The electroactive polymeric membrane 111, the substrate 112, and the dielectric fluid 113 of the vibration generation device 110 configured to generate the substantial massage vibration in addition to the cover member 102 contacting the user’s body and the first soft filler material 101 may include the soft material, thereby minimizing the foreign body sensation when the user’s skin contacts.

Here, an operation principle of the vibration cushion according to the present invention composed of the above configuration will be described as follows.

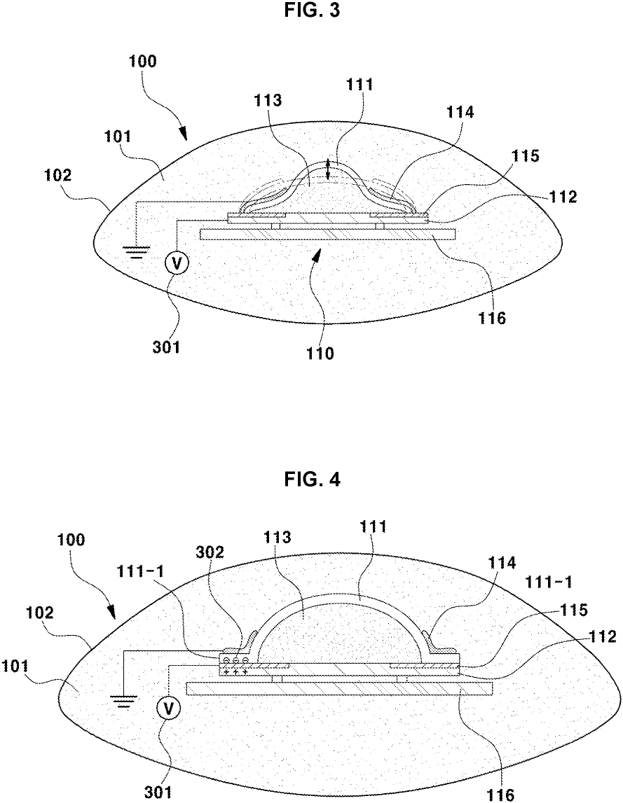

FIG. 3 is a cross-sectional diagram showing an exemplary vibration operation principle of the flexible vibration cushion according to an exemplary embodiment of the present invention.

When a power source is supplied to the electrode 115 from an external power source 301 through the substrate 112 in a state where the external power source 301 is connected to the substrate 112, an attraction by an electric field, that is, an electrostatic force may be generated between the electrode 115 coated on the substrate 112 and the flexible electrode 114 coated on the electroactive polymeric membrane 111.

There may occur a phenomenon in which the outer end (rim portion) of the electroactive polymeric membrane 111 coated with the flexible electrode 114 and the outer portion (rim portion) of the substrate 112 coated with the electrode 115 are in close contact with each other by the thus generated electrostatic force.

Substantially, as shown in FIG. 3, there may occur a contraction phenomenon in which the outer end (rim portion) of the electroactive polymeric membrane 111 is in close contact with the surface of the substrate 112 by the thus generated electrostatic force.

At this time, the outer end of the electroactive polymeric membrane 111 may be in close contact with the surface of the substrate 112 to pressurize the dielectric fluid 113 filled in the space between the electroactive polymeric membrane 111 and the substrate 112 from the outside to the inside.

Subsequently, the dielectric fluid 113 may be pushed from the outside to the inside to serve as a pressure pushing the central portion of the electroactive polymeric membrane 111 forward, and therefore, as shown in FIG. 3, the central portion of the electroactive polymeric membrane 111 may expand and protrude forward for generating the vibration.

On the other hand, when the power source supplied to the electrode 115 from the external power source 301 is cut off, the electrostatic force generated between the electrode 115 coated on the substrate 112 and the flexible electrode 114 coated on the electroactive polymeric membrane 111 may be released.

Therefore, the outer end of the electroactive polymeric membrane 111 may be returned to the original position by releasing the electrostatic force, and the pressure of the dielectric fluid 113 pushing forward and pressurizing the central portion of the electroactive polymeric membrane 111 may be released, and therefore, the central portion of the electroactive polymeric membrane 111 may be contracted and retreated to the original position for generating the vibration.

As described above, the change in the physical shape including an operation in which the central portion of the electroactive polymeric membrane 111 may expand and protrude forward by the electrostatic force, an operation in which the central portion of the electroactive polymeric membrane 111 may be contracted and retreated to the original position by releasing the electrostatic force, etc. may be repeated, thereby generating the vibration for massage.

Meanwhile, if the supply of the external power source 301 is changed with time, the expansion degree of the electroactive polymeric membrane 111 is changed with time, thereby generating the physical feel such as the vibration, and the size and frequency of the vibration at this time may be interlocked with the size and frequency of the power source supplied.

For example, as a greater voltage is supplied from the external power source 301, a stronger electrostatic force may be generated between the flexible electrode 114 and the electrode 115. Therefore, an area at which the electrostatic polymeric membrane 111 and the substrate 112 may be in close contact with each other can be broader, and a pressure at which the dielectric fluid 113 may push the central portion of the electroactive polymeric membrane 111 further increases, and therefore, the central portion of the electroactive polymeric membrane 111 may further protrude, thereby increasing the size of the vibration for massage.

FIG. 4 is a cross-sectional diagram showing a flexible vibration cushion according to another exemplary embodiment of the present invention.

For example, the electroactive polymeric membrane 111 may be made of a PVC-gel material that is a material with a high permittivity and well causes a surface charge induction phenomenon to generate a larger electrostatic force with respect to the same power source.

As shown in FIG. 4, a charge transfer terminal 111-1 may be formed to extend from the outer end of the electroactive polymeric membrane 111 made of the PVC-gel material and stacked and attached on the electrode 115 of the substrate 112.

Therefore, on the outer end of the electroactive polymeric membrane 111, the flexible electrode 114 coated on the first surface portion of the electroactive polymeric membrane 111 and the electrode 115 of the substrate 112 may be in a state of facing each other with the charge transfer terminal 111-1 of the electroactive polymeric membrane 111 interposed therebetween.

Therefore, when the power source is supplied to the electrode 115 from the external power source 301 through the substrate 112, a charge 302 may move from the charge transfer terminal 111-1 toward the electrode 115 as shown in FIG. 4, thereby shortening a distance between the electrode 115, which is the anode, and the charge, and therefore, a stronger electrostatic force is generated between the electrode 115 and the flexible electrode 114 under a condition in which the same voltage is applied.

As described above, when the stronger electrostatic force is generated between the electrode 115 and the flexible electrode 114, the outer end of the electroactive polymeric membrane 111 may be in close contact with the surface of the substrate 112 substantially to pressurize the dielectric fluid 113 filled in the space between the electroactive polymeric membrane 111 and the substrate 112 from the outside to the inside.

At the same time, as the dielectric fluid 113 may be pushed further from the outside to the inside, its pressure pushing the central part of the electroactive polymeric membrane 111 forward further may increase, and therefore, a length at which the central part of the electroactive polymeric membrane 111 may expand and protrude forward can further increase, thereby improving the vibration generation performance of the vibration generation device, including an increase in the vibration intensity for massage.

Here, an example of the control method for driving the flexible vibration cushion according to an exemplary embodiment of the present invention will be described as follows.

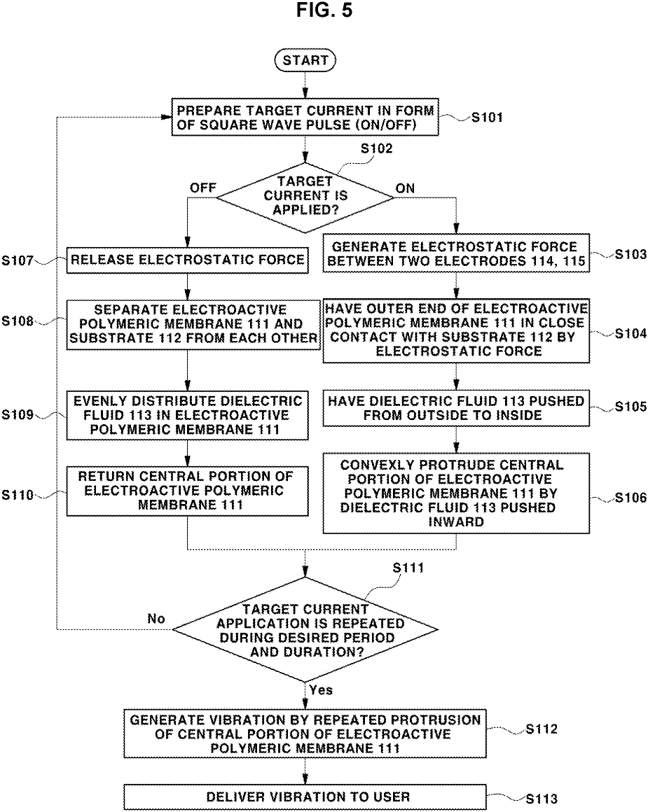

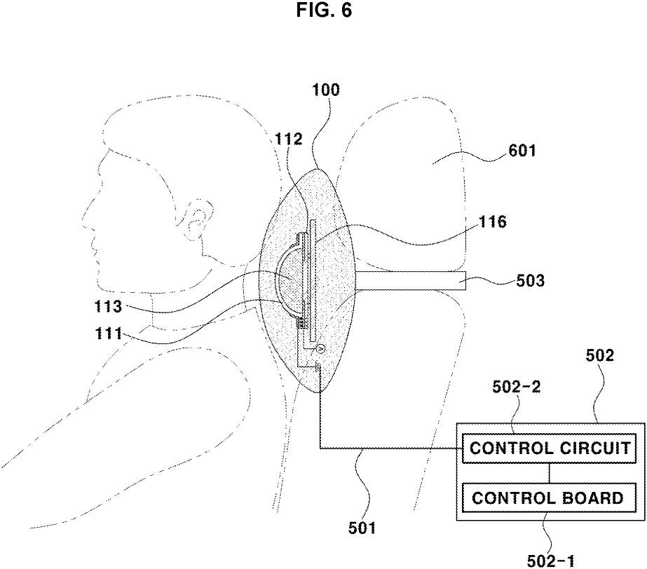

FIG. 5 is a flowchart showing an exemplary control method for driving the flexible vibration cushion according to an exemplary embodiment of the present invention, and FIG. 6 is a side cross-sectional diagram showing an example in which the flexible vibration cushion according to an exemplary embodiment of the present invention is mounted outside a headrest of a vehicle.

As shown in FIG. 6, the vibration cushion 100 may be mounted on the outside of the headrest of the vehicle by an extendable band 503.

In addition, a control unit 502 including a control circuit 502-2, which is a driver for a current control, and a control board 502-1 may be connected to the vibration generation device 110 existing in the vibration cushion 100, and the control unit 502 can be mounted in a seatback or a storage box behind the seat.

The control unit 502 may prepare a target current in the form of a square wave pulse in which an ON section where a current is applied and an OFF section where the current is cut off are repeated (S101).

Subsequently, when the power source is supplied to the vibration generation device 110 from the external power source 301, the control unit 502 may apply the target current to the substrate 112 in the form of the square wave pulse in which the ON section where the current is applied and the OFF section where the current is cut off are repeated (S102).

At this time, when the current is supplied to the electrode 115 through the substrate 112 in the ON section where the current is applied by the control unit 502, the electrostatic force may be generated between the electrode 115 coated on the substrate 112 and the flexible electrode 114 coated on the electroactive polymeric membrane 111 (S103).

Due to the thus generated electrostatic force, there occurs a phenomenon in which the outer end (rim portion) of the electroactive polymeric membrane 111 and the outer portion (rim portion) of the substrate 112 are in close contact with each other (S104).

Substantially, as shown in FIG. 3, there may occur a contraction phenomenon in which the outer end (rim portion) of the electroactive polymeric membrane 111 is in close contact with the surface of the substrate 112 by the thus generated electrostatic force.

Subsequently, the outer end of the electroactive polymeric membrane 111 may be in close contact with the surface of the substrate 112 and pressurizes the dielectric fluid 113 filled in the space between the electroactive polymeric membrane 111 and the substrate 112 from the outside to the inside, and therefore, the dielectric fluid 113 is pushed from the outside to the inside (S105).

Subsequently, the dielectric fluid 113 may be pushed from the outside to the inside to serve as a pressure pushing the central portion of the electroactive polymeric membrane 111 forward, and therefore, as shown in FIG. 3, the central portion of the electroactive polymeric membrane 111 may expand and protrude forward (S106).

On the other hand, when the current to the electrode 115 is cut off in the OFF section where the current is cut off by the control unit 502, the electrostatic force generated between the electrode 115 coated on the substrate 112 and the flexible electrode 114 coated on the electroactive polymeric membrane 111 may be released (S107).

Therefore, the outer end of the electroactive polymeric membrane 111 may be returned to the original position by releasing the electrostatic force, and therefore, the electroactive polymeric membrane 111 and the substrate 112 may be in a state of being spaced apart from each other by an original distance (S108).

Subsequently, the pressure of the dielectric fluid 113 pushing the central portion of the electroactive polymeric membrane 111 forward may be released so that the dielectric fluid 113 is evenly distributed in the electroactive polymeric membrane 111 (S109), and the central portion of the electroactive polymeric membrane 111 may be contracted and returned to the original position (S110).

At this time, the control unit 502 confirms whether the target current in the form of the square wave pulse in which the ON section where the current is applied and the OFF section where the current is cut off are repeated may be applied during a desired period and duration (S111).

As the result of confirmation, the process may be ended if the target current is applied during the desired period and duration, and otherwise, the target current may be applied during the desired period and duration.

As described above, the change in the physical shape including the operation in which the central portion of the electroactive polymeric membrane 111 may expand and protrude forward by the electrostatic force, the operation in which the central portion of the electroactive polymeric membrane 111 may be contracted and returned to the original position by releasing the electrostatic force, etc. may be repeated, thereby generating the vibration for massage (S112), and the vibration at this time may be delivered to the user to perform the massage (S113).

Meanwhile, the vibration generation device 110 may generate various types of vibrations according to the current application pattern in addition to the vibration for massage.

For example, when various information such as a safety warning, a vehicle destination guidance, a stopover sign, and a proceeding direction of the vehicle are provided to the control unit 502 from a vehicle control unit, the control unit 502 may select a current application pattern suitable for the relevant information to apply it to the electrode of the substrate, thereby providing senses of the vibrations corresponding to various information (warning, guidance, sign, direction recognition, etc.) to the user, and the user can recognize the information through tactile sensation.

Particularly, when the vehicle information of any one of the safety warning, the vehicle destination guidance, the stopover sign, and the proceeding direction of the vehicle may be provided to the control unit 502 from the vehicle control unit, the control unit 502 applies the current application pattern suitable for the vehicle information to the substrate of the vibration generation device, and therefore, the vibration generation device can generate the vibration according to the current application pattern suitable for the vehicle information based on the aforementioned vibration generation principle. Therefore, the user may recognize the relevant vehicle information through the tactile sensation.

Alternatively, when sound source information is provided to the control unit 502 from the vehicle control unit, the control unit 502 may select the current application pattern suitable for the sound source information to apply it to the electrode of the substrate, thereby providing the vibration suitable for a sense of rhythm when the user listens to music, etc. to the user, and the user can feel a sense of music rhythm through the tactile sensation.

Particularly, when the sound source information is provided to the control unit 502 from the vehicle control unit, the control unit 502 may select the current application pattern suitable for the sound source information to apply it to the substrate of the vibration generation device, and therefore, the vibration generation device may generate the vibration with the sense of rhythm according to the current application pattern suitable for the sound source information based on the aforementioned vibration generation principle, and the user can feel the sense of music rhythm through the tactile sensation when listening to the music.

The vibration cushion according to an exemplary embodiment of the present invention may be embedded in a vehicle part, e.g., the headrest of the vehicle seat.

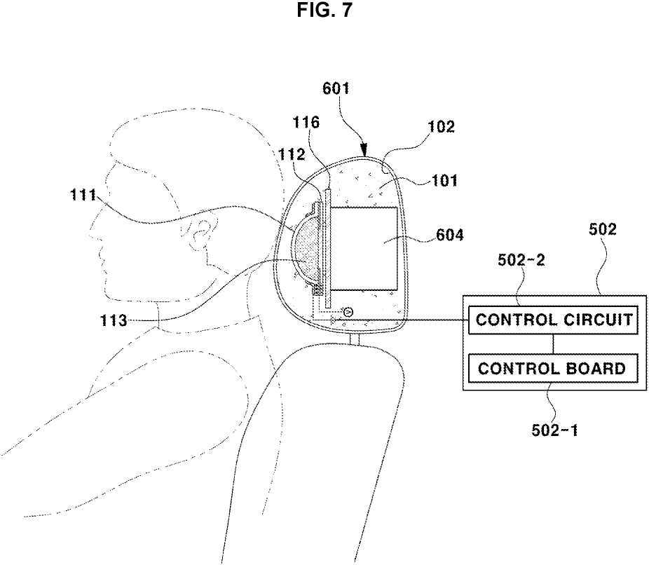

FIG. 7 is a side cross-sectional diagram showing an example in which the flexible vibration cushion according to an exemplary embodiment of the present invention is embedded in the headrest of the vehicle.

When the vibration cushion 100 according to the present invention is embedded in a headrest 601 of the vehicle, the first soft filler material 101 sealed with the cover member 102 may be embedded in the headrest 601, and the vibration generation device 110 is disposed in the first soft filler material 101.

Preferably, the vibration generation device 110 in the first soft filler material 101 may be disposed inside the first of the headrest 601 close to the lower side of the back of the passenger’s head so that the vibration can be well delivered to the passenger.

In particular, when the vibration generation device 110 generates the vibration according to the aforementioned operation principle, a second soft filler material 604 higher than that of the first soft filler material 101 may be attached to a second side of the support structure 116 in the configuration of the vibration generation device 110 to obtain a sufficient reaction force in a state where its position is not changed.

The hardness of the second soft filler material 604 attached to the second side of the support structure 116 may be preferably about 30 to 70% greater than that of the first soft filler material 101.

Therefore, the passenger can feel a soft tactility by the first soft filler material 101, and the reaction force when the vibration generation device 110 generates the vibration based on the aforementioned operation principle is easily absorbed and supported by the second soft filler material 604.

Polymer materials (e.g. polyethylene, polyester, polyurethane, and/or vegetal cellulose) suitably may be used as second soft filler materials. Sponge materials including synthetic sponge materials also are suitable and may include various polymer materials.

As described above, even when the vibration cushion according to the present invention is embedded in the headrest, the change in the physical shape including the operation in which the central portion of the electroactive polymeric membrane 111 may expand and protrude forward by the electrostatic force, the operation in which the central portion of the electroactive polymeric membrane 111 is contracted and returned to the original position by releasing the electrostatic force, etc. may be repeated as described above, thereby generating the vibration for massage, and the vibration at this time may be delivered to the passenger to perform the massage.

Likewise, when various information such as the safety warning, the vehicle destination guidance, the stopover sign, and the proceeding direction of the vehicle may be provided to the control unit 502 from the vehicle control unit, the control unit 502 may select the current application pattern suitable for the relevant information to apply it to the electrode of the substrate, thereby providing the sense of vibration corresponding to various information (warning, guidance, sign, direction recognition, etc.) to the passenger (in particular, driver), and the passenger can recognize the information through the tactile sensation.

In addition, when the sound source information is provided to the control unit 502 from the vehicle control unit, the control unit 502 may select the current application pattern suitable for the sound source information to apply it to the electrode of the substrate, thereby providing the vibration suitable for the sense of rhythm when the user listens to music, etc. to the user, and the passenger may feel the sense of music rhythm through the tactile sensation.

As described above, the electroactive polymeric membrane 111, the substrate 112, and the dielectric fluid 113, etc. of the vibration generation device 110 configured to generate the substantial vibration for massage in addition to the cover member 102 contacting the user’s body and the first soft filler material 101 can include the soft material, thereby minimizing the foreign body sensation when the user’s skin contacts, and minimizing or preventing the phenomenon in which the local pressure concentration acts on the user’s body contacting the vibration cushion when the situation such as the collision of the vehicle occurs, thereby inflicting the injury.

In addition, by allowing the user to freely modify the change in the vibration pattern including the vibration amplitude and frequency of the vibration generation device, it is possible to variously implement the sense of vibration delivered to the user.

While the present invention has been described above in detail through various exemplary embodiments, the scope of the present invention is not limited to the aforementioned exemplary embodiments, and various modifications and improvements by those skilled in the art using the basic concept of the present invention defining the appended claims will also be included in the scope of the present invention.

What is claimed is:

1. A flexible vibration cushion comprising:
a cover member;
a first soft filler material filled in the cover member; and
a vibration generation device comprising components made of a soft material and disposed in the soft filler, and configured to generate vibration as an electrostatic force is repeatedly generated and released.

2. The flexible vibration cushion of claim 1,
wherein the vibration generation device comprises:
a substrate coated with an electrode;
an electroactive polymeric membrane bonded to a first surface portion of the substrate;
a dielectric fluid injected into a space between the substrate and the electroactive polymeric membrane; and
a flexible electrode coated on the dielectric fluid to face and contact the electrode of the substrate.

3. The flexible vibration cushion of claim 2,
wherein a second surface portion of the substrate is further connected with a support structure configured to limit the vibration such that the vibration generated by the vibration generation device is absorbed into or reflected from the first soft filler material on a second side of the substrate.

4. The flexible vibration cushion of claim 2,
wherein the electroactive polymeric membrane comprises a convex membrane structure comprising a polymer material with an elastic force.

5. The flexible vibration cushion of claim 2,
wherein the flexible electrode comprises one or more selected from a carbon nanotube, a metal nanoparticle, a graphene, a conductive polymer, and a hydrogel.

6. The flexible vibration cushion of claim 2,
wherein the electroactive polymeric membrane comprises a PVC-gel material, and a charge transfer terminal stacked between the flexible electrode coated on the electroactive polymeric membrane and the electrode coated on the substrate is formed to extend from an outer end of the electroactive polymeric membrane.

7. The flexible vibration cushion of claim 2,
wherein when a power source is supplied to the substrate, an electrostatic force is generated between the electrode coated on the substrate and the flexible electrode coated on the electroactive polymeric membrane, and an outer end of the electroactive polymeric membrane is in close contact with an outer portion of the substrate.

8. The flexible vibration cushion of claim 7, wherein the dielectric fluid is pushed from the outside to the inside to pressurize a central portion of the electroactive polymeric membrane, and the central portion of the electroactive polymeric membrane protrudes forward for generating the vibration.

9. The flexible vibration cushion of claim 8,
wherein when the power source to the substrate is cut off, the electrostatic force generated between the electrode coated on the substrate and the flexible electrode coated on the electroactive polymeric membrane is released, and the outer end of the electroactive polymeric membrane is returned to an original position.

10. The flexible vibration cushion of claim 9,
wherein the pressure of the dielectric fluid pushing the central portion of the electroactive polymeric membrane is released, and the central portion of the electroactive polymeric membrane is contracted and retreated to the original position for generating the vibration.

11. A headrest of a vehicle comprising:
a flexible vibration cushion of claim 1,
a second soft filler material having a hardness greater than that of the first soft filler material filled in the cover member and attached to a second side of the support structure of the vibration generation device.

12. A vehicle comprising a headrest of claim 11.

13. A method of controlling a flexible vibration cushion, comprising:
applying, by a control unit, a target current in the form of a square wave pulse in which an ON section where a current is applied and an OFF section where the current is cut off are repeated to a substrate;
expanding and protruding forward a central portion of an electroactive polymeric membrane by generating an electrostatic force between an electrode coated on the substrate and a flexible electrode coated on the electroactive polymeric membrane in the ON section; and
contracting and retreating the central portion of the electroactive polymeric membrane to an original position by releasing the electrostatic force between the electrode coated on the substrate and the flexible electrode coated on the electroactive polymeric membrane in the OFF section,
wherein the central portion of the electroactive polymeric membrane protrudes forward and is retreated to the original position repeatedly so that the vibration is generated.

14. The method of claim 13,
wherein the expanding and protruding forward of the central portion of the electroactive polymeric membrane includes:
closely contacting and contracting an outer end of the electroactive polymeric membrane with an outer portion of the substrate by generating the electrostatic force, pressurizing and pushing the dielectric fluid filled in the space between the electroactive polymeric membrane and the substrate from the outside to the inside, and serving the dielectric fluid as a pressure pushing the central portion of the electroactive polymeric membrane forward as it is pushed from the outside to the inside.

15. The method of claim 13,
wherein the contracting and retreating the central portion of the electroactive polymeric membrane to the original position comprises:
separating the electroactive polymeric membrane and the substrate from each other by an original distance by returning the outer end of the electroactive polymeric membrane to the original position by releasing the electrostatic force, and releasing the pressure of the dielectric fluid pushing the central portion of the electroactive polymeric membrane forward.

16. The method of claim 13, further comprising:
providing any one of vehicle information items including a safety warning, a vehicle destination guidance, a stopover sign, and a proceeding direction of a vehicle to the control unit from a vehicle control unit;
applying, by the control unit, a current application pattern suitable for the vehicle information to the substrate of a vibration generation device; and
generating, by the vibration generation device, a vibration suitable for the vehicle information according to the current application pattern suitable for the vehicle information.

17. The method of claim 13, further comprising:
providing sound source information to the control unit from a vehicle control unit;
selecting, by the control unit, a current application pattern suitable for sound source information to apply it to the substrate of a vibration generation device; and
generating, by the vibration generation device, a vibration with a sense of rhythm according to the current application pattern suitable for the sound source information.
